(19) United States
(12) Patent Application Publication
(10) Pub. No.: US 2010/0034950 A1
(43) Pub. Date: Feb. 11, 2010

(54) Method and system for flash freezing coffee-flavored liquid and making cold coffee-based beverages

(76) Inventors: Curt Jones, (US); Robert Lynn, (US)

Correspondence Address: STOCKWELL & SMEDLEY, PSC, 861 CORPORATE DRIVE, SUITE 200, LEXINGTON, KY, 40503, US

(21) Appl. No.: 12/462,896

(22) Filed: Aug. 11, 2009

Related U.S. Application Data
(60) Provisional application No. 61/188,595, filed on Aug. 11, 2008.

(51) Int. Cl. A23F 5/30; A23F 5/00; A23F 5/46; A23F 5/38

(52) U.S. Cl. 426/595; 426/594; 426/384

(57) ABSTRACT

An apparatus and method of flash freezing a coffee-based liquid into small beads and then packaging the beads for consumers is disclosed. The beads are stored in a conventional freezer until desired and then reconstituted into a coffee beverage base as needed. In particular, a cold coffee-based beverage may be easily and affordably created using the frozen beads.

### RELATED APPLICATIONS

The present application claims priority to provisional Patent Application Ser. No. 61/188,595 filed Aug. 11, 2008, the disclosure of which is incorporated by reference herein, in its entirety.

### FIELD OF THE INVENTION

The present invention relates to beverages and more particularly to an apparatus and method for creating a flash frozen coffee beverage.

### BACKGROUND OF THE INVENTION

Various coffee-based drinks are available such as cappuccino, espresso, flavored-coffees, and regular coffee. Some drinks are served chilled, some hot, and some with extra ingredients and toppings as well. Regardless of the way most coffee-based drinks are served, they typically start out as coffee beans that are brewed, steamed, roasted, or processed at the location where the drink is being served.

Keeping coffee beans fresh is important to maintaining the flavor and aroma of drinks made using those beans. There are many techniques that have previously been used to try to maintain the freshness of coffee beans. While vacuum packing and other packaging are known techniques, it is also well known that freezing coffee beans appears to help maintain their freshness.

However, enjoying a fresh tasting coffee drink requires either a laborious process at home using consumer-quality equipment or traveling to a coffee specialty shop where commercial-grade equipment can produce a quality drink but often at a hefty price. There remains the need, therefore, for a product and method of its manufacture and use which allows quality coffee flavored drinks to be easily and affordably produced by a typical consumer.

### SUMMARY OF THE INVENTION

Embodiments of the present invention relate to a method of flash freezing a coffee-based liquid into small beads and then packaging the beads for consumers. The beads are stored in a conventional freezer until desired and then reconstituted into a coffee beverage base as needed. In particular, a cold coffee-based beverage may be easily and affordably created using the frozen beads.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

FIG. 1 depicts flash freezing apparatus in accordance with the principles of the present invention.

FIG. 2 depicts exemplary beads in accordance with the principles of the present invention.

FIG. 3 depicts a flowchart of an exemplary method for making flash frozen coffee-based beads according to an embodiment of the present invention.

FIG. 4 depicts a flowchart of an exemplary method for making flash frozen coffee-based beads according to another embodiment of the present invention.

FIG. 5 depicts a flowchart of an exemplary method of making a cold coffee-based beverage in accordance with the principles of the present invention.

### DETAILED DESCRIPTION OF THE PREFERRED EMBODIMENTS

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

As a result of the methods described herein, there are provided formulations of frozen coffee-based beverages in the form of small particulate shapes that remain free-flowing during storage and which can be used alone or in combination to be reconstituted into various coffee-based beverages. The particulate shapes, generally referred to as “beads”, may have a generally spherical, spheroid shape but may also have an oblong, elliptical, oblate, tubular, or other slightly irregular shape. In addition to having an irregular overall shape, the surface of the particulate shape may also be either smooth or irregular (e.g. bumpy, pocked, etc.). On average, the particulate shapes will preferably have a diameter of about 5 mm or less but can also be larger such as between about 6 and about 10 mm. Particulate shapes having diameters outside these ranges are also contemplated. For non-spherical shapes which do not have a conventional diameter, the diameter is considered to be the diameter of the smallest sphere into which the particulate shape would fit.

It is desired that the particulate or beaded product is in a free-flowing format so that it is readily pourable or spoonable. Free-flowing, as used herein, is a broad term which includes the ability of the product to flow as individual particulate shapes, with little or no clumping or sticking to each other, during such pouring or spooning. There may be slight sticking after a period of storage, but a light tap on the container will unstick the particulate shapes and allow them to be free flowing. The generally spherical shape helps contribute to the free-flowing, pourable product.

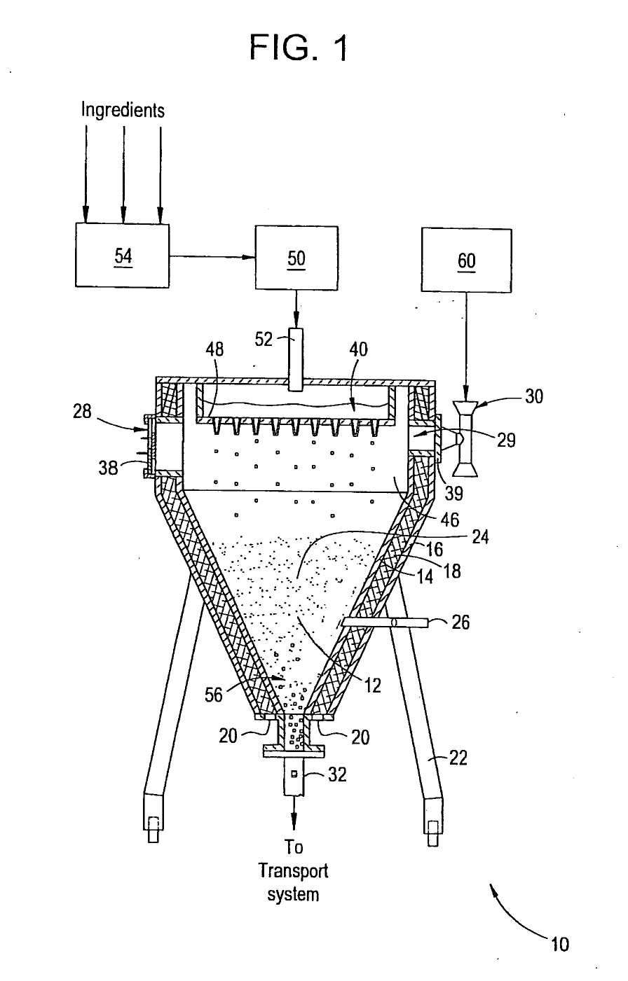

FIG. 1 shows a cryogenic processor constructed in accordance with an embodiment of the present invention to produce free-flowing beads 56.

A cryogenic processor 10 includes a freezing chamber 12 that is most preferably in the form of a conical tank that holds a liquid refrigerant therein. A freezing chamber 12 incorporates an inner shell 14 and an outer shell 16. Insulation 18 is disposed between the inner shell 14 and outer shell 16 in order to increase the thermal efficiency of the chamber 12. Vents 20 are also provided to ventilate the insulated area formed between the shells 14 and 16. The freezing chamber 12 is a free-standing unit supported by legs 22.

A refrigerant 24, preferably liquid nitrogen, enters the freezing chamber 12 by means of refrigerant inlet 26. The refrigerant 24 is introduced into a chamber 12 through the inlet 26 in order to maintain a predetermined level of liquid refrigerant in the freezing chamber because some refrigerant 24 can be lost by evaporation or by other means incidental to production. Gaseous refrigerant that has evaporated from the surface of the liquid refrigerant 24 in freezing chamber 12 primarily vents to the atmosphere through exit port 29 which cooperates with the vacuum assembly 30, which can be in the form of a venturi nozzle. Extraction of the frozen beads occurs through product outlet 32 adapted at the base of the freezing chamber 12.

An ambient air inlet port 28 with adjustment doors 38 and exit port 29 with adjustment doors 39 are provided to adjust the level of gaseous refrigerant which evaporates from the surface of the liquid refrigerant 24 so that excessive pressure is not built up within the processor 10 and freezing of the liquid composition in the feed assembly 40 does not occur.

A feed tray 48 receives liquid composition from a delivery source 50. Typically, a pump (not shown) drives the liquid composition through a delivery tube 52 into the feed tray 48. A premixing device 54 allows several compositions, not all of which must be liquid, such as powdered flavorings or other additives of a size small enough not to cause clogging in the feed assembly 40, to be mixed in predetermined concentrations for delivery to the feed tray 48.

In order to create uniformly sized particles or beads 56 of frozen product, uniformly sized droplets of liquid composition are desirable that are to be fed through gas diffusion chamber 46 to freezing chamber 12. The feed tray 48 is designed with feed assembly 40 that forms droplets of the desired character. The frozen product takes the form of beads that are formed when the droplets of liquid composition contact the refrigerant vapor in the gas diffusion chamber 46, and subsequently the liquid refrigerant 24 in the freezing chamber 12. After the beads 56 are formed, they fall or are mechanically directed to the bottom of chamber 12. A transport system connects to the bottom of chamber 12 at outlet 32 to carry the beads 56 to a packaging and distribution network for later delivery and consumption.

The vacuum assembly 30 cooperates with air inlet 28 and adjustment doors 38 so that ambient air flows through the inlet and around feed assembly 40 to ensure that no liquid composition freezes therein. This is accomplished by mounting the vacuum assembly 30 and air inlet 28 on opposing sides of the gas diffusion chamber 46 such that the incoming ambient air drawn by the vacuum assembly 30 is aligned with the feed assembly. In this configuration, ambient air flows around the feed assembly warming it to a sufficient temperature to inhibit the formation of frozen liquid composition in the feed assembly flow channels. An air source 60, typically in the form of an air compressor, is attached to vacuum assembly 30 to provide appropriate suction to create the ambient air flow desired.

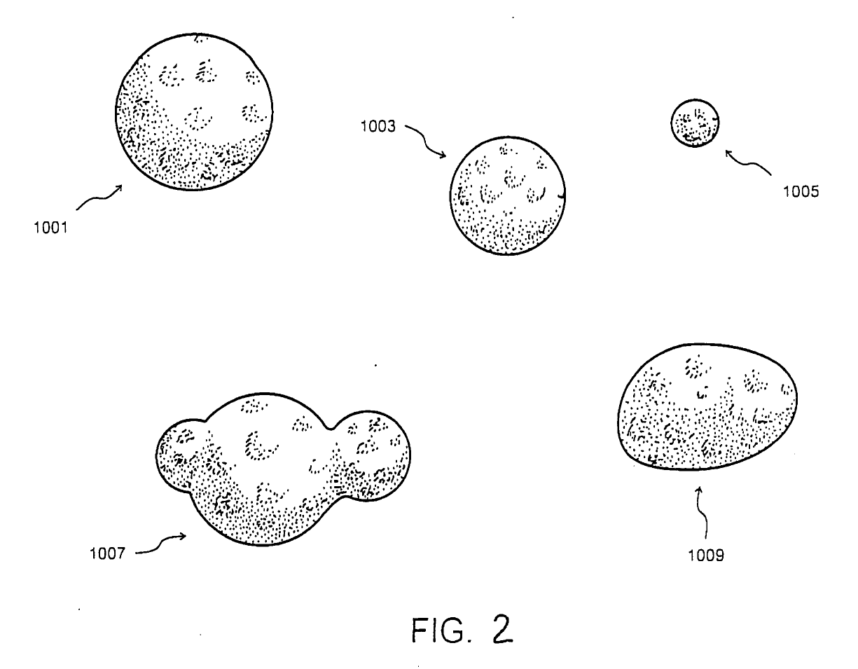

In accordance with preferred embodiments, there are provided formulations of frozen coffee flavored confections in the form of small particulate shapes. The particulate shapes may have a generally spherical, spheroid shape as shown in FIG. 2 (e.g., 1001, 1003, 1005), but may also have an oblong, elliptical, oblate, tubular, or other slightly irregular shape as also shown in FIG. 2 (e.g., 1007, 1009). In addition to having an irregular overall shape, the surface of the particulate shape may also be either smooth or irregular (e.g. bumpy, pocked, etc.). On average, the particulate shapes will preferably have a diameter of about 0.05 inch to about 0.5 inch or less, including 0.4 inch, 0.3 inch, 0.25 inch, 0.2 inch, 0.15 inch, and about 0.1 inch, and ranges including and bordered by these dimensions. Particulate shapes having diameters outside these ranges are also contemplated. For non-spherical shapes which do not have a conventional diameter, the diameter is to be the diameter of the smallest sphere into which the particulate shape would fit.

As mentioned earlier, it is desired that the beaded product is in a free-flowing format so that it is readily pourable or spoonable. Free-flowing, as used herein, is a broad term which includes the ability of the product to flow as individual particulate shapes, with little or no clumping or sticking to each other, during such pouring or spooning. There may be slight sticking after a period of storage, but a light tap on the container will unstick the particulate shapes and allow them to be free flowing. The generally spherical shape helps contribute to the free-flowing, pourable product.

In preferred embodiments, particulate shapes that can be stored at higher temperatures, such as in a home freezer or in a grocery dairy freezer are provided, such particulate shapes being able to maintain a free-flowing form while being stored at a temperature between about −10° F. and 0° F. with an occasional rise to perhaps as much as +5° F. One way to accomplish this is to increase the freezing point (reduce the freeze-point depression) of the liquid formulation that forms the particulate shapes, although other ways may also be used.

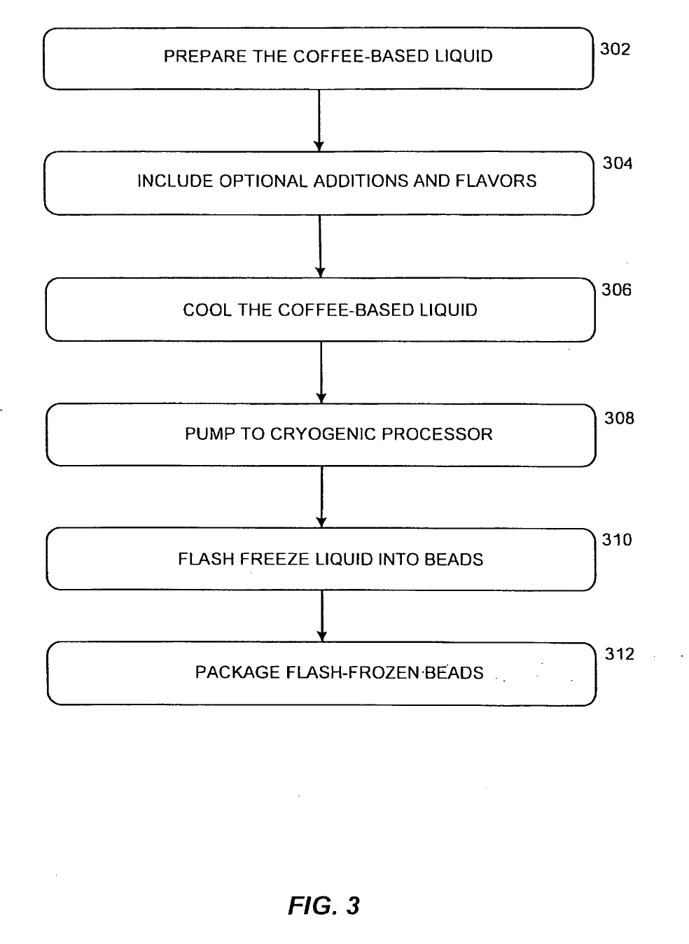

FIG. 3 depicts a flowchart of an exemplary method of making a coffee-based particulate beads in accordance with the principles of the present invention.

The first step 302 shown in FIG. 3 is that of preparing the coffee-based liquid. While the base ingredient of this liquid is coffee, there are a number of additional ingredients and flavors that may be added as well during the preparation process, in accordance with other embodiments. Dairy products, flavored syrups, flavored oils, sugars, sweeteners, herbs, spices and the like may be added, for example in a raw form or pre-processed form. In preparing the coffee-based liquid, the coffee may be brewed, steamed or pressed to have a particular strength, caffeine content, or other desired characteristic. Also, flavors from various liqueurs and syrups, as well as the ingredients listed above, may be part of the formulation as well, either before or after the coffee-based liquid is prepared. The number of various formulations that may be turned into coffee-based liquids in accordance with the principles of the present invention are limited only by the creativity of the food scientist and the preferences of consumers.

As is known, coffee-based liquids may be prepared by various brewing methods as well as alternative methods as well. For example, in accordance with at least one embodiment, the coffee-based liquid is substantially traditional espresso. Espresso is prepared from dark, roasted coffee beans that are first ground to a desired size. Then water at around 195 to 200° F. is forced through the finely ground coffee at between 9-15 bars of pressure. The resulting coffee-based liquid has a highly concentrated coffee flavor.

Once the liquid is prepared, another opportunity exists, at step 304, to add additional flavors, ingredients or additives in order to formulate a variety of different coffee-based liquids. In step 306, the coffee-based liquid is cooled. The cooling can be accomplished by a variety of different methods that are well known. Preferably the coffee-based liquid is cooled to about 40° F. in a matter of minutes or less. While as low a temperature as possible is desirable to improve the efficiency of later cryogenic processing, the temperature to which the liquid is cooled depends on the desired viscosity of the liquid as it is transported through to later stages of processing. Thus, additives may be included, such as stabilizers, that allow cooling to lower temperatures while ensuring the liquid easily flows and improve the liquids freezing characteristics. The coffee-based liquid is transported such as by being pumped, in step 308, to a frozen bead-making apparatus such as, for example, the device shown and described earlier with respect to FIG. 1. As mentioned, the consistency of the liquid may be adjusted to accommodate the pump 50 and the temperature of the liquid may be adjusted as well by well known cooling techniques that can be applied during transport to the freezing apparatus. The temperature and consistency may also adjusted to help the development of uniformly-sized beads within the freezing apparatus. Depending on the viscosity of the original fluid, different temperatures and consistencies may be used for different liquids that are dispensed into the freezing apparatus.

The next step, 310, is to freeze the coffee-based liquid into beads as described with respect to FIG. 1. These beads can then be transported to a packaging machine. The transporting of the beads can be accomplished in a variety of different ways such as by a feed screw, a moving conveyor belt, or gravity feed. The transporting means can also be cooled such that the beads remain cool while being transported to the packager. In general, the entire process from the grinding of the coffee beans to the packaging and storing of the beads can be accomplished in a time-frame measured in minutes and is, preferably accomplished in less than 10 minutes. In this way, a flash-frozen coffee-based product is produced that can be easily reconstituted to make a fresh tasting coffee beverage. However, process times greater than or less than 10 minutes may be desirable in some embodiments and are contemplated within the scope of the present invention.

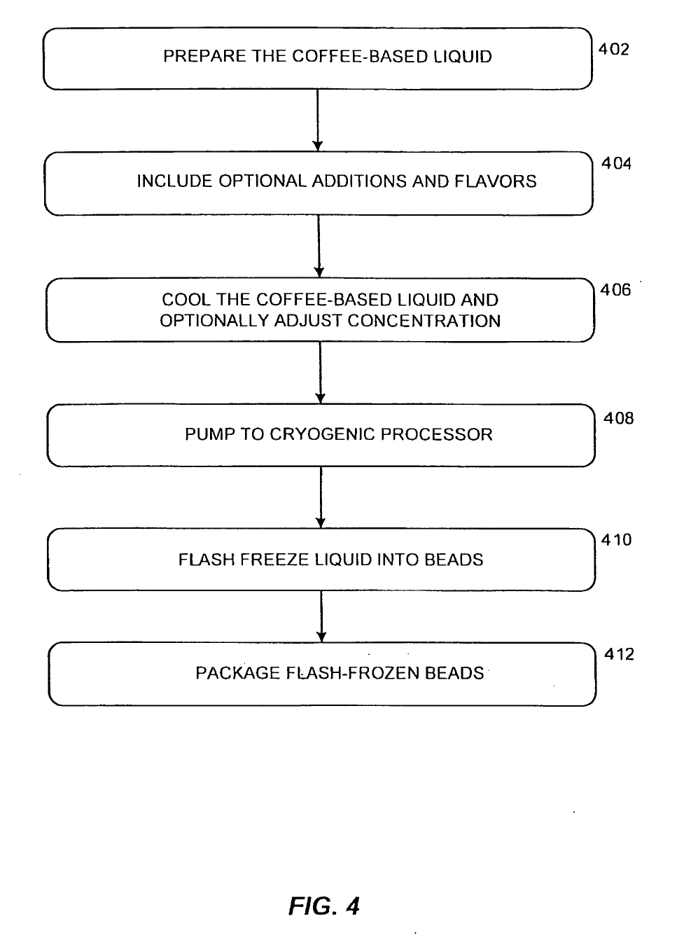

Using the example embodiment described above, the resulting coffee-based frozen particulate beads can have a relatively highly concentrated coffee flavor. Alternatively, the coffee-based liquid that is fed through the cryogenic process may be freshly brewed coffee instead of espresso. FIG. 4 depicts a flowchart of an exemplary method of producing frozen beads using brewed coffee. The steps are substantially the same as the steps described with respect to FIG. 3. In step 402, the coffee-based liquid is prepared such as by brewing coffee using known techniques and then additional flavors or additives can be incorporated in step 404. If necessary, the resulting liquid can then be cooled in step 406, transported to a cryogenic processor, in step 408, where it is flash frozen into beads, in step 410. Once flash frozen, the beads can then be packaged, in step 412, and stored.

The brewed coffee liquid may have a consistency and viscosity that is not optimal for transporting and freezing. For example, the water content may be too high for efficient bead formation and freezing. Additionally, the ultimate beverage that results when the beads are reconstituted may require so many beads to have the desired coffee flavor that the product is unappealing. Thus, in step 406, the coffee-based liquid may be concentrated by extracting a portion of the water as it is cooled. The resulting liquid may therefore have a stronger coffee flavor and be easier to freeze into relatively uniform beads. However, using original strength brewed coffee is contemplated as well.

One of ordinary skill will recognize that different flavored beads may be frozen in separate freezing apparatuses at the same time or in the same freezing apparatus in a sequential manner. These different flavor beads can then be combined in different ratios at the packaging machine. In this way, different combinations of flavored coffee-based beverages may be created using the same set of beads in various permutations and combinations. Of course, a product consisting of one type of flavored bead is contemplated.

Once the beads are packaged and delivered to a consumer such as an individual, a coffee shop, a store, or a restaurant, the beads are stored in a conventional freezer until they are used to make a beverage. Although the beads are frozen at cryogenic temperatures, there is no requirement that they remain cooled to temperatures as low as −40° F. but, instead, may be maintained at the standard operating temperatures of commercial and consumer freezers. However, storing them at even lower temperatures may allow using less of the beads to cool a beverage to a desired temperature.

In addition to the espresso beads and the brewed coffee beads discussed above, embodiments of the present invention also contemplate coffee-flavored beads as well that more closely resemble flash frozen ice cream products. These beads have a less concentrated coffee flavor than beads made substantially from brewed coffee or espresso. Thus, in addition to coffee-based beverages being obtainable, beverages having more subtle coffee flavor are also possible. Instead of espresso or brewed coffee being the liquid or slurry that is flash frozen, a coffee-flavored mixture as described below is flash frozen to form beads having coffee flavor (and additional flavors if desired). For any of the types of beads discussed, the apparatus and method of FIG. 1 may used as well as other cryogenic freezing processes.

An exemplary method of manufacturing the coffee-flavored frozen food product, includes preparing a formulation, wherein the formulation is preferably made by combining liquid ingredients, combining dry powders, and mixing the combined dry powders with the combined liquids to make the formulation, and where the method continues by agitating the formulation, pasteurizing the formulation, homogenizing the formulation, aging the formulation, and dripping the formulation into a cryogenic processor to form a particulate frozen food product. In a preferred embodiment, the homogenizing step acts to synchronize the pasteurizing step. In certain embodiments, based on the ingredients of the formulation, the pasteurizing step may be omitted. Also, one or more of the other steps in the above list may be optional depending on the formulation and desired end product.

One example of a formulation for a coffee-flavored frozen food product, includes water and total solids, wherein the food product may include, in addition to coffee flavor, 6-14% by weight milk fat, 4-24% by weight non-fat milk solids, and 2.6-8% by weight sugar. In preferred products the product is in the form of particulate shapes which remain free-flowing when stored in a freezer at 0° F. In certain embodiments, the food product further includes one or more of the following: 0.1-0.4% by weight sweetener; 1-20% by weight bulking agent; 0.1-1% by weight of cryoprotectant; one or more natural and/or artificial flavors; and 1-4% combined stabilizer/emulsifier. In certain embodiments, the product may have at least about 29% by weight total solids and less than about 71% by weight water allowing the product to remain free flowing when stored in a freezer at 0° F. Preferred bulking agents include, but are not limited to, maltodextrins.

As stated, it is desired to store the particulate shapes within a conventional freezer and yet still maintain their free-flowing properties. To achieve this, various sample liquid formulations used in making the particulate shapes will now be described some which are dairy based and some which are not. It should be noted that the formulations described below are only examples, and numerous other formulations containing various amounts of ingredients as described herein may be made. Some of the components of three different example formulation types are as follows (all percentages are by weight of the total formulation):

| Ingredient | Formulation I | Formulation II | Formulation III |
|---|---|---|---|
| Milk fat (butterfat) | 9-11% | 6-14% | |
| Non-fat milk solids | 4-12% | 4-20% | |
| Maltodextrins (or other | 0-20% | 0-20% | 0-10% |
| bulking agent) | | | |
| Sugar | 15-17% | 2.6-8% | 2-10% |
| sweetener (artificial) | | <0.4% | <0.8% |
| combined | <1% (if | <4% (if | <1% (stabilizer |
| stabilizer/emulsifier | present) | present) | only) |
| total solids | >=35.5% | >=29.7% | |
| Water (coffee flavor) | <=63.5% | <=70.3% | 70-96% |

The freezing point of the various formulations disclosed herein which form the particulate shapes can be increased by making adjustments to one or more of the above components, and some adjustments work better in combination with each other. As shown above, some of the formulations above comprise various total solids combined with water. Within the particulate shapes, water is present both as a liquid and as a solid. This is because not all water freezes, due to the presence of dissolved solutes and the cryogenic freezing itself. The solid/liquid ratio within the particulate shapes affects their firmness. This in turn affects pourability and the ability of the particulate shapes to remain free-flowing. Other factors may affect the pourability, including, but not limited to, size of the ice crystals, freezing point, melting point, glass transition temperature, presence or absence of devitrification, storage temperature and conditions.

In the United States, the total solids content must be 35.55% to legally describe a product as ice cream. Accordingly, formulations according to formulation I are considered ice creams in the U.S. This is because most ice creams finished ice cream product must weight at least 4.5 lb/gal and must contain at least 1.6 lb of food solids or total solids per gallon, which essentially equates to a minimum total food solids of 35.5%. In the USA, any finished product below these limits cannot be labeled ice cream. However, other countries have different requirements. For example, in several countries other than the U.S. the total solids content of a formulation can be as low as 29.7%, and possibly lower, yet still be labeled ice cream. Accordingly, formulations according to Formulation II preferably have solids at a level that is considered ice cream in jurisdictions outside the U.S. Therefore, in certain preferred embodiments, the total solids in a frozen confection is at least about 25%, at least about 26%, at least about 26.5%, at least about 27%, at least about 27.5%, at least about 28%, at least about 28.5%, at least about 29%, at least about 30%, at least about 31%, at least about 32%, at least about 33%, at least about 34%, at least about 35%, at least about 36%, or at least about 37%, wherein stated percentages are by weight of the weight of the total formulation including water.

One component of the solids of dairy formulations such as those according to Formulae I and II is milkfat. The milkfat, also called butterfat, in the composition provides much of the creamy texture and body to the formulation, with higher levels providing greater creaminess and richness.

Serum solids or nonfat milk solids are those components of milk and/or cream which are water soluble, including but not limited to caseins and other milk proteins. It is to be noted that although milkfat and water are listed as separate ingredients, milkfat, water and serum solids are, in most embodiments, included in the milks and creams that form the basis of the dairy Formulations I and II, and thus do not necessarily comprise separate ingredients.

Nonfat milk solids enhance the texture of ice cream, aid in giving body and chew resistance, and may be less expensive than milkfat. Whey solids, including modified whey products, may also be substituted for nonfat milk solids but, under USA federal government requirements, not for more than 25% of the total nonfat milk solids in the overall formulation. Egg yolk can also be used as another source of solids. Accordingly, in one embodiment, preferably about 1% to 25%, including 5% to 20% and 10% to 15% of the nonfat milk solids in a formulation comprise whey solids and/or egg yolk solids.

Emulsifiers can also be included within the various formulations, especially those containing milkfat. Preferred emulsifiers can include monoglycerides, diglycerides, and polysorbates. Stabilizers may be included within the various formulations. Stabilizers assist in controlling the viscosity of the formulations, with more stabilizer generally providing increased viscosity, especially in those embodiments having lower amounts of fats and solids. The viscosity affects the drip rate of the formulation while it is formed. Within the dairy Formulations I and II, preferred stabilizers can include guar, carrageenan, LBG, and/or CMC. Within the non-dairy Formulation III, a preferred stabilizer can include cellulose gum.

In those dairy embodiments where both stabilizers and emulsifiers are used, the formulations disclosed herein for making the frozen confection includes a combined stabilizer/emulsifier, and the recited amounts are the combined total of the stabilizer and emulsifier present. The combined stabilizer/emulsifier need not actually be added as a single ingredient when making the formulation; the weights of these two materials are included together because in many embodiments, commercial combined stabilizer/emulsifier formulations are used, which include one or more stabilizers and one or more emulsifiers. Accordingly, the stabilizer/emulsifier may be a commercial or proprietary formulation or it may be a combination or series of one or more stabilizers and/or one or more emulsifiers added to the formulation.

One or more bulking agents may also be added to formulations according to certain embodiments. Bulking agents include high molecular weight polymeric compounds (such as polysaccharides), which add viscosity and bulk to foods. Preferred bulking agents include, but are not limited to polydextrose, dextrans, corn syrup solids, and maltodextrins. In certain preferred embodiments, maltodextrins are used, including, but not limited to, those having a DE of 5, 10, 15, and 20, where DE refers to “dextrose equivalent”. In a preferred embodiment, the total amount of bulking agents is 1% to 20% by weight, including 1%-15% by weight, 5%-15% by weight, including 6%, 8%, 10% and 12% by weight. Because bulking agents and stabilizers both contribute to the viscosity of a formulation, formulations containing a bulking agent may or may not include a stabilizer or stabilizer/emulsifier.

The ultimate use for the frozen beads is to use them to produce a beverage for consumption. This can be accomplished in a variety of different ways without departing from the scope of the present invention. For example, for warm beverages, the frozen beads may be brewed or steamed to reconstitute them much like coffee beans. The frozen beads may also be ground similar to regular coffee beans and used to make espresso and other similar beverages. However, another benefit of the frozen beads is that they may be used or mixed to create cold coffee-based drinks while reducing or eliminating the need for ice cubes. Thus, the resulting beverage is not as watered-down as if ice cubes are used to make the cold drink. Also, because of the freezing method, ice crystal formation will be different than if ice cubes are used which improves the mouth-feel of the resulting beverage. Milk, water and other liquids may be used when reconstituting the frozen beads into the desired beverage. A combination of any or just some of the brewed coffee beads, the espresso beads, and the coffee-flavor beads can be formulated in order to achieve a desired coffee flavor strength for a variety of different cold drinks.

Accordingly, the packaging of the frozen beads can be accomplished in a variety of different ways depending on the desired product. For example, the beads may be packed in a cup sized container that is for a single serving. For example, 8 oz. of beads (whatever variety or combination) may be packaged in a cup with room for 8 oz. of milk (or other liquid) to be added. Additional room can be provided in order to accommodate other additional flavors and confections. Alternatively, the beads can be packaged in bulk packages from which a user can extract the desired amount of product to be reconstituted.

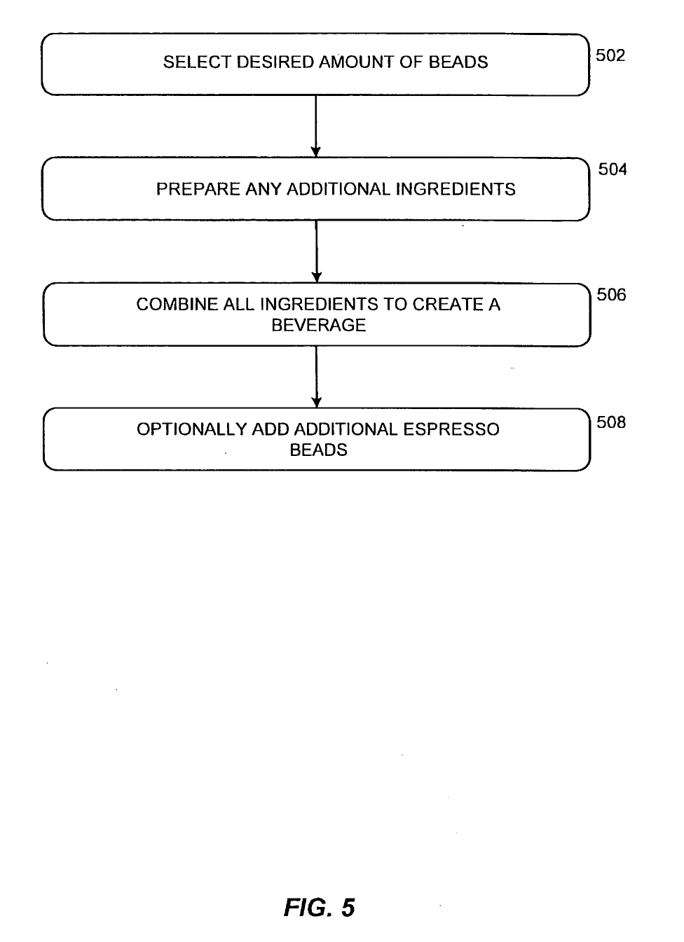

Utilizing the espresso beads, brewed coffee beads, and the coffee flavored beads described earlier, various ingredients can be added to create any of the well known cold coffee beverages currently available and those to be created in the future. In general, a flowchart is shown in FIG. 5 of a method for making a coffee drink from the frozen beads described earlier. In step 502, the desired amount of beads are acquired. While these beads can be any of the flash-frozen coffee-based, or coffee-flavored beads as described earlier, using the coffee-flavored beads will allow more subtle coffee flavors to be created which can always be augmented by other more strongly flavored beads. Depending on the desired beverage and the type of beads, the amount of beads selected in step 502 will vary.

The ingredients that will be combined with this coffee beverage base can vary widely. For example, milk, frothed milk, steamed milk, cream, and whipped cream are all likely candidates to add so as to make a variety of cold coffee-based beverages. Furthermore, the milk can vary from 1%, 2%, skim, lowfat, whole, and untraditional milk products such as soy, rice, goat, and the like. These additional ingredients can also includes syrups and flavors such as those traditionally paired with coffee such as chocolate, vanilla, hazelnut, Irish creme, caramel, peppermint, butter rum, mint, coffee liqueur, and others. In cold coffee beverages fruity flavors, soda water, and ice can be added as well. Thus, in step 504, the additional ingredients are prepared in a manner appropriate for addition to the coffee beverage base and then everything is combined in step 506 to create a cold coffee beverage. In step 508, the strength of the coffee flavor in the cold beverage can be increased by adding either espresso beads or brewed coffee beads as desired by the user.

As an example recipe, 8 oz. of coffee-flavored beads can be combined with 8 oz. of milk to yield a cold coffee drink of about 16 oz. The beads and milk can, for example, be combined by shaking or using a blender. The resulting beverage can be garnished with additional ingredients such as whipped cream, chocolate sauce, or caramel sauce.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An edible product comprising:
cryogenically frozen coffee-flavored formulation in a beaded shape.

2. The edible product of claim 1, further comprising:
cryogenically frozen espresso in a beaded shape.

3. The edible product of claim 1, further comprising:
cryogenically frozen brewed coffee in a beaded shape.

4. The edible product of claim 1, wherein the beaded shape is approximately between 5 mm and 10 mm in diameter.

5. The edible product of claim 1, further comprising:
a plurality of beads of cryogenically frozen coffee-flavored formulation, wherein the plurality of beads remains pourable at a temperature of approximately 0° F.

6. The edible product of claim 1, wherein the coffee-flavored formulation comprises:
6-14% by weight milk fat;
4-24% by weight non-fat milk solids;
2.6-8% by weight sugar; and
0-0.4% by weight sweetener.

7. The edible product of claim 1, wherein the coffee-flavored formulation comprises:
6-20% by weight milk fat;
4-16% by weight non-fat milk solids;
0-19% by weight bulking agents;
2.6-8% by weight sugar;
0-0.4% by weight sweetener; and
0-4% by weight combined stabilizer and emulsifier.

8. The edible product of claim 1, wherein the coffee-flavored formulation comprises:
2-10% by weight sugar;
0.1-1.0% by weight sweetener; and
0-2% by weight stabilizer.

9. A method of making a coffee-flavored product, comprising:
making a coffee-flavored formulation; and
cryogenically freezing the coffee-flavored formulation to form a plurality of beads of the coffee-flavored product.

10. The method of claim 9, wherein the plurality of beads remains pourable at a temperature of approximately 0° F.

11. The method of claim 9, wherein the coffee-flavored formulation comprises:
6-14% by weight milk fat;
4-24% by weight non-fat milk solids;
2.6-8% by weight sugar; and
0-0.4% by weight sweetener.

12. The method of claim 9, wherein the coffee-flavored formulation comprises:
6-20% by weight milk fat;
4-16% by weight non-fat milk solids;
0-19% by weight bulking agents;
2.6-8% by weight sugar;
0-0.4% by weight sweetener; and
0-4% by weight combined stabilizer and emulsifier.

13. The method of claim 9, wherein the coffee-flavored formulation comprises:
2-10% by weight sugar;
0.1-1.0% by weight sweetener; and
0-2% by weight stabilizer.

14. A cold coffee-flavored drink comprising:
a plurality of beads of cryogenically frozen coffee-flavored formulation; and
an additional liquid ingredient.

15. The cold coffee-flavored drink of claim 14, further comprising:
a plurality of beads of cryogenically frozen espresso.

16. The cold coffee-flavored drink of claim 14, wherein the additional liquid ingredient comprises milk.

17. The cold coffee-flavored drink of claim 14, wherein the additional liquid ingredient comprises a flavored syrup.

18. A method of making a cold coffee-flavored drink comprising:
selecting a plurality of beads of cryogenically frozen coffee-flavored formulation;
selecting an additional liquid ingredient; and
mixing the plurality of beads with the additional liquid ingredient to form the cold coffee-flavored drink.

19. The method of claim 18, further comprising:
adding additional flavoring to the cold coffee-flavored drink.

20. The method of claim 18, further comprising:
adding a plurality of beads of cryogenically frozen espresso to the cold coffee-flavored drink.
